(19) United States
(12) Patent Application Publication
(10) Pub. No.: US 2025/0296825 A1
(43) Pub. Date: Sep. 25, 2025

(54) CONTAINER OPENER

(71) Applicant: Glenard Wang Hon KWOK, Hong Kong (HK)

(72) Inventor: Glenard Wang Hon KWOK, Hong Kong (HK)

(21) Appl. No.: 19/086,897

(22) Filed: Mar. 21, 2025

Related U.S. Application Data
(60) Provisional application No. 63/568,056, filed on Mar. 21, 2024.

(51) Int. Cl. B67B 7/18

(52) U.S. Cl. CPC B67B 7/186

(57) ABSTRACT

The present application provides a container opener designed to address the difficulty of opening well-sealed containers with bare hands and the ergonomic shortcomings of existing openers. The opener includes a housing, an adjustment mechanism, a handle, and a locking assembly. The container opener accurately adjusts the length of the strip to accommodate container caps of different sizes. Once the adjustment is complete, the length of the extended strip can be locked to prevent the container opener from loosening during the cap-opening process. Additionally, the container opener provides reliable friction with the cap, effectively preventing relative rotation when tightly engaged. Furthermore, the container opener is designed with ergonomic features to enhance user-friendliness. In some application scenarios, the container opener may also be used as a tool to close the cap to the container.

### CROSS-REFERENCE TO RELATED APPLICATIONS

This application claims the benefit of U.S. provisional patent application No. 63/568,056, filed on Mar. 21, 2024, which is incorporated herein by reference in its entirety.

### TECHNICAL FIELD

The present disclosure generally relates to the field of opening sealed container tools, and more particularly to a container opener.

### BACKGROUND

Bottles, jars, or other containers with caps must be opened to access their contents for use or consumption. However, the smooth and tight outer surfaces of some caps make it difficult to grip and open using hands manually.

To address this, people commonly use a variety of container openers, such as wrenches, pliers, vice grips and other tools to open caps. However, existing container openers still face several shortcomings that necessitate further optimization.

For example, wrenches are characterized by their simple structure and low cost, but they are limited to a single bottle size. Openers with gear teeth can accommodate a range of cap sizes. However, these openers require the user to manually increase friction between the gear teeth and the cap for an extended period before the cap can be opened. This can be challenging for individuals with limited hand strength, such as the elderly or children.

### SUMMARY

The subject matter disclosed herein comprises a container opener for opening a sealed container. The container opener includes a housing having a cavity extending along a longitudinal axis from a front end adapted for engaging a container cap to a rear end opposite the front end. An adjustment mechanism is disposed within the cavity, and includes a guide member disposed within the cavity and extending along the longitudinal axis, a moving block coupled to the guide member and configured to move relative to the housing; and a strip having a partially portion positioned outside a front end of the housing, with two ends extending into the cavity and coupled to the moving block. A handle is operatively coupled to the adjustment mechanism to drive movement of the moving block.

The container opener further includes various features for improved functionality and ease of use. According to one or more embodiments of the present disclosure, the guide member includes a threaded rod rotatably coupled to the housing and extending along the longitudinal axis and a rail disposed within the cavity and parallel to the threaded rod. The moving block defines a threaded bore engaged with the threaded rod and includes a sliding interface mating with the rail to prevent rotation of the moving block. The handle is operatively coupled to the threaded rod to drive rotation thereof.

According to one or more embodiments of the present disclosure, the front end of the housing defines two through-holes; and the two ends of the strip extend into the cavity through the two through-holes and are respectively connected to opposite sides of the moving block. The housing includes an arcuate surface positioned between the two through-holes, and the arcuate surface cooperates with a portion of the strip positioned outside the housing to define a receiving space configured to receive the container cap. At least one of the arcuate surface and the portion of the strip positioned outside the housing comprises a friction portion disposed on a side facing the receiving space. The friction portion is elastic and/or includes a plurality of protrusions.

According to one or more embodiments of the present disclosure, the handle is sleeved over a portion of the housing and rotatably coupled to the housing. The handle comprises a tubular structure including an inner wall with an annular protrusion; and the housing has an outer wall defining a corresponding annular groove. The annular groove is configured to slidably engage with the annular protrusion. The threaded rod includes an external spline at a rear end thereof; and the handle includes an internal spline cooperatively engaged with the external spline. The internal spline is disposed at a rear end of the handle.

According to one or more embodiments of the present disclosure, the housing includes a first section including a rear end defining an opening corresponding to the rear end of the threaded rod. The handle is rotatably mounted on the first section and drivingly coupled to the threaded rod via the opening. The housing further includes a second section extending from a front end of the first section. The second section includes a rear end with a cross-sectional dimension larger than a cross-sectional dimension of the first section, and a front end defining two through-holes for the strip. The first section tapers in cross-sectional dimension from the front end to rear end.

A front end of the threaded rod is rotatably coupled to the front end of the second section. A rear end of the threaded rod is rotatably coupled to the rear end of the first section.

According to one or more embodiments of the present disclosure, the container opener further includes a locking assembly, the locking assembly is slidably mounted on the housing and operable between a locked position engaging the handle to prevent rotation thereof and an unlocked position disengaged from the handle to permit rotation thereof.

According to one or more embodiments of the present disclosure, the locking assembly includes an outer gear ring and an outer ring. The outer gear ring is slidably mounted on the housing and configured to move along the longitudinal axis, and the handle has an inner surface with inner gear teeth, and the inner gear teeth are configured to engage with the outer gear ring. The outer ring surrounds the outer gear ring and is coupled to an end of the outer gear ring distal from the handle, wherein a gap between an inner wall of the outer ring and an outer wall of the outer gear ring has a thickness not less than a wall thickness of the handle. The outer gear ring defines a sliding groove extending along the longitudinal axis on an inner wall thereof, and the housing includes a ridge protruding from an outer wall thereof and slidably coupled to the sliding groove.

The outer gear ring includes first teeth circumferentially spaced along the outer wall thereof. Wherein at least one of the first gear teeth or the inner gear teeth are distributed over an entirety of a 360 degrees circumference. The locking assembly further includes a washer mounted on the housing and interposed between the outer gear ring and housing. The washer has an outer wall in sliding contact with the inner wall of the outer gear ring.

According to one or more embodiments of the present disclosure, a container opener includes a housing having a cavity extending along a longitudinal axis from a front end adapted for engaging a container cap to a rear end opposite the front end. An adjustment mechanism is disposed within the cavity, and includes a guide member disposed within the cavity and extending along the longitudinal axis, a moving block coupled to the guide member and configured to move relative to the housing; and a strip having a partially portion positioned outside a front end of the housing, with two ends extending into the cavity and coupled to the moving block. A handle is operatively coupled to the adjustment mechanism to drive movement of the moving block. A locking assembly is slidably mounted on the housing and operable between a locked position engaging the handle to prevent movement thereof; an unlocked position disengaged from the handle to permit movement thereof.

Numerous benefits and advantages of this application will become apparent to those skilled in the art upon reading and understanding the following detailed specification.

### BRIEF DESCRIPTION OF THE DRAWINGS

It should be expressly understood that the drawings are for purposes of illustration and description only and are not intended as definitions of the limitations of the application.

FIG. 1 is a perspective view of a container opener in one embodiment;

FIG. 2 is a partially exploded perspective view illustrating an adjustment mechanism in a cavity;

FIG. 3 illustrates a housing having a first section and a second section;

FIG. 4 illustrates the mounting positions of a rail and friction portion;

FIG. 5 illustrates the position of washers on the housing;

FIG. 6 is a perspective view of a handle;

FIG. 7 is a partially exploded perspective view of a handle, illustrating the fixation element therein;

FIG. 8 is a perspective view of a locking assembly;

FIG. 9 is an exploded perspective view of a locking assembly.

### DETAILED DESCRIPTION OF THE EMBODIMENTS

The following clearly and completely describes the technical disclosures in the embodiments of this application with reference to the accompanying drawings in the embodiments of this application. Based on the embodiments in this application, all other embodiments obtained by those skilled in the art without creative efforts fall within the protection scope of this application.

It is understood that although the terms “first,” “second,” and the like may be used herein to described different elements, these elements should not be limited by these terms. These terms are merely used to distinguish one element from another.

It should be further noted that the terms “front”, “rear”, “left”, “right”, “upper” and “lower” used in the following description refer to directions in some embodiments. The terms “inner” and “outer” are used to refer to directions toward or away from the geometric center of a particular component, respectively. In addition to the orientations described in the drawings, these terms should also encompass other orientations of the device.

The present disclosure relates to a container opener configured to open caps and other closures. The container opener accurately adjusts the length of the strip to accommodate bottle caps of different sizes. Once the adjustment is complete, the length of the strip can be locked to prevent the container opener from loosening during the cap-opening process. Additionally, the container opener provides reliable friction with the cap, effectively preventing relative rotation when tightly engaged. Furthermore, the container opener is designed with ergonomic features to enhance user-friendliness.

Although the term “container” is often used in the present disclosure, any type of container is intended, and may include, without limitation, bottles, jars, canisters, medicine bottles, jugs, cans, drums, and all other containers.

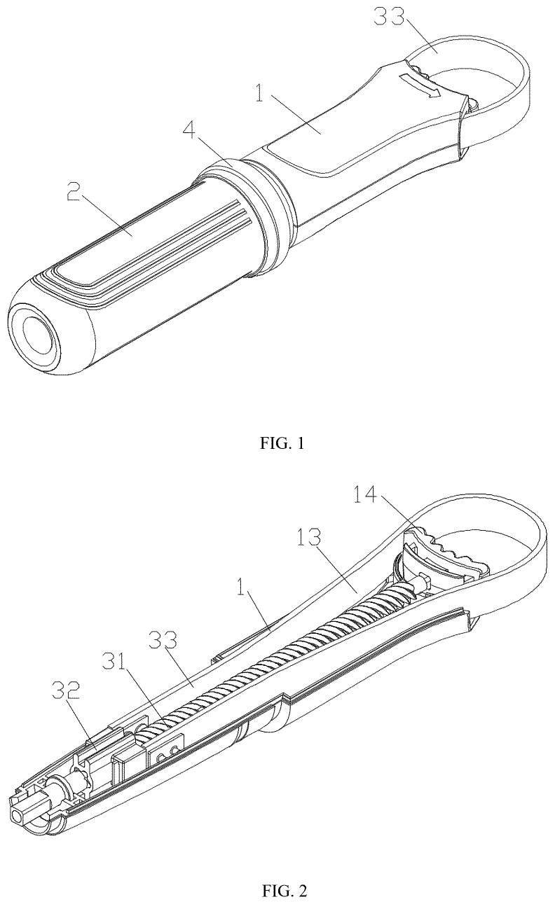

As shown in FIG. 1 to FIG. 4, a container opener includes a housing 1, an adjustment mechanism 3 and a handle 2. The housing 1 defines a cavity 13 extending along a longitudinal axis from a front end adapted for engaging a container cap to a rear end opposite the front end, and the cavity 13 is configured to accommodate the adjustment mechanism 3.

For ease of description in the embodiments of the present disclosure, the end proximate to the container is defined as a front end, and the end distal from the container is defined as a rear end.

The adjustment mechanism 3 includes a guide member, a moving block 32 and a strip 33. The guide member is disposed within the cavity 13 and extending along the longitudinal axis. The moving block 32 is coupled to the guide member and configured to move relative to the housing. In one embodiment, the guide member includes a threaded rod 31 and a rail 34. The threaded rod 31 is disposed in the housing 1 and rotatably connected to the housing 1. The threaded rod 31 extends along the longitudinal axis. An opening is provided on the housing 1 corresponding to the rear end of the threaded rod 31. The rail 34 is disposed within the housing 1 and extends parallel to the threaded rod 31. The moving block 32 with a threaded bore engaged with the threaded rod 31, and a sliding interface operatively coupled to the rail 34 to prevent rotation of the moving block 32. The guide member and moving block 32 cooperatively form a mechanism similar to a lead screw mechanism, and the mechanism is configured to convert rotational motion into linear motion. Rotation of the threaded rod 31 causes the moving block 32 to move along the threaded rod 31 and the rail 34.

The strip 33 has a middle portion located outside a front end of the housing 1, with its two ends extending into the housing 1 and connected to the moving block 32. As the moving block 32 moves along the threaded rod 31, the strip 33 moves with the moving block 32, and the length of the strip 33 extending out of the housing 1 changes accordingly to adapt to caps of different sizes.

The handle 2 is operatively coupled to the threaded rod 31 to drive its rotation, thereby adjusting the positions of the moving block 32 and the strip 33. The handle 2 and the threaded rod 31 may be coupled via splines.

In one embodiment, the front end of the housing 1 is provided with two through-holes in a symmetrical arrangement. The two ends of the strip 33 each extend into the cavity 13 through the respective through-holes. The two ends of the strip 33 are respectively connected to opposite sides of the moving block 32, such that the motion states of the two ends of the strip 33 are uniformly synchronized.

The housing 1 has an arcuate surface, the arcuate surface positioned between the two through-holes, and the arcuate surface cooperates with a portion of the strip 33 extending outside the housing 1 to define a receiving space configured to receive the container cap. The arcuate surface configuration provides compliant adaptation to the contour of the cap.

In one embodiment, the arcuate surface includes a friction portion disposed on a side facing the receiving space. The friction portion 14 is in contact with the cap, and increase the friction force between them, thereby preventing the container opener from rotating relative to the cap during the cap-opening process. Moreover, the friction portion 14 is configured to provide a cushioning effect, thereby preventing damage to the housing 1. In other embodiment, the strip 33 includes a friction portion disposed on a side facing the receiving space. In other embodiment, the arcuate surface and the strip 33 include a friction portion disposed on a side facing the receiving space.

The friction portion 14 may include a plurality of protrusions. The friction portion 14 is clastic and provides a buffering effect when locking the strip 33, protecting the housing 1 and/or the container cap from damage. The friction portion 14 may be formed of rubber or other material having resilient properties.

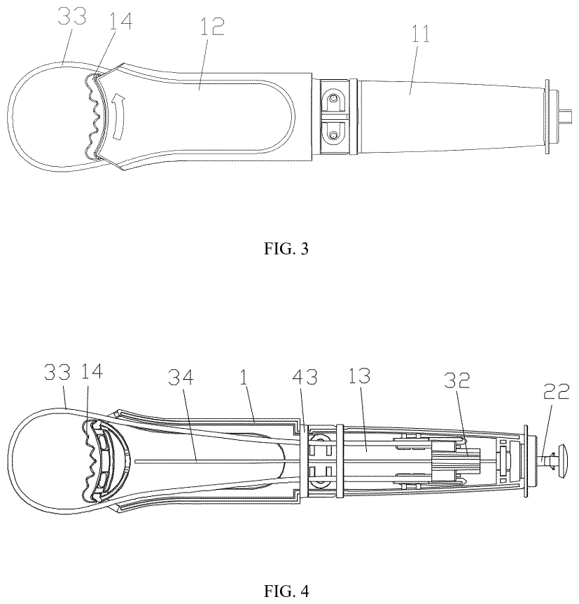

As shown in FIG. 3, in one embodiment, the housing 1 includes a first section 11 and a second section 12 extending from a front end of the first section 11. The first section 11 has a circular cross-section, and the opening is located at a rear end of the first section 11.

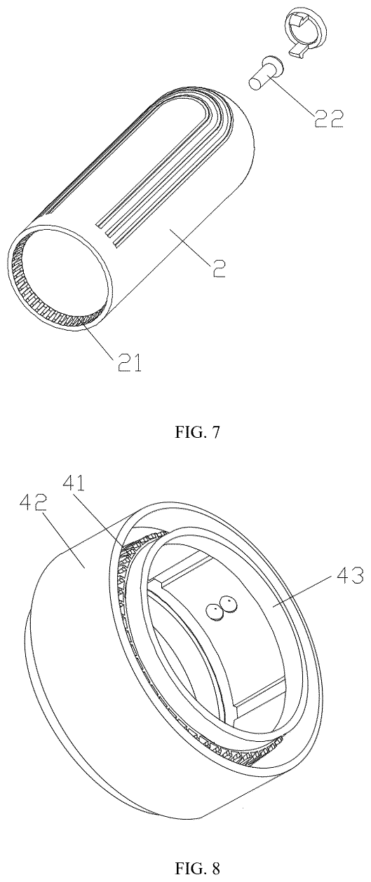

The handle 2 is concentrically disposed about a longitudinal portion of the first section 11 and rotatably coupled to at least part of the first section 11. As shown in FIG. 6, the handle 2 may comprise a tubular structure having an inner wall provided with an annular protrusion, while the outer wall of the first section 11 defines a corresponding annular groove. The annular protrusion is slidably coupled to the annular groove, thereby enabling rotational connection between the handle 2 and the housing 1.

The cross-sectional dimension of the first section 11 is smaller than that of the rear end of the second section 12. The handle 2 has a cross-sectional dimension substantially identical to the rear end of the second section 12, such that when the handle 2 is mounted on the first section 11, its overall dimension substantially matches the second section 12, thereby improving visual continuity and aesthetic appearance.

The first section 11 has a cross-sectional dimension tapered from the front end to rear end, so that the inner wall of the first section 11 is configured to constrain the position of the strip 33, thereby reducing the likelihood of torsional deformation of the strip 33, and ensuring smooth extension and retraction of the strip 33. In order to facilitate user grip, the handle 2 maintains a substantially constant cross-sectional dimension.

A front end of the second section 12 defines two through-holes, and the strip 33 extends through the through-holes. Specifically, the front end of the second section 12 has a substantially rectangular cross-sectional shape, and the rear end of the second section 12 has a substantially circular cross-sectional shape, conforming to ergonomic design principles.

The front end of the threaded rod 31 is rotatably coupled to the front end of the second section 12. The rear end of the threaded rod 31 is rotatably supported by a support plate fixedly connected to the rear end of the first section 11, thereby ensuring smooth rotation of the threaded rod 31 within the housing 1.

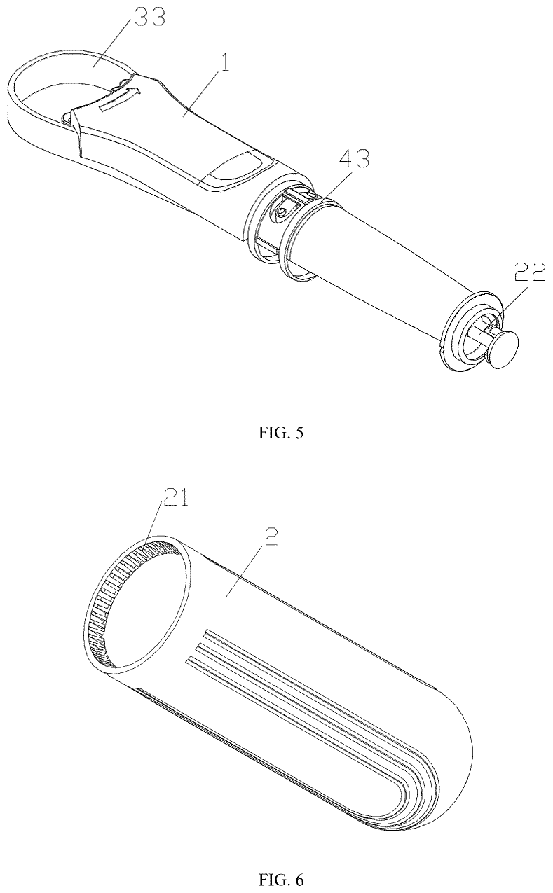

In one embodiment, the first section 11 is formed by detachably coupling two first half-housings. The second section 12 is formed by detachably coupling two second half-housings. The detachable coupling of the half-housings allows users to easily disassemble the housing 1 for inspection, repair, or replacement of internal components. Each first half-housing is integrally formed with a corresponding second half-housing, providing enhanced durability and simplified assembly. The two first half-housings may be coupled via bolted connections or snap-fit engagements. A ring is sleeved over the rear end of the first section 11 to enhance the connection reliability between the two first half-housings as illustrated in FIG. 4 and FIG. 5. The two first half-housings may be coupled via bolted connections or snap-fit engagements.

In one embodiment, the first section 11 is formed by detachably coupling two first half-housings. The second section 12 is formed by detachably coupling two second half-housings. Each first half-housing is detachably coupled to a corresponding second half-housing.

In one embodiment, an external spline is disposed at the rear end of the threaded rod 31, and an internal spline is disposed in the handle 2. The external spline and the internal spline are mated at the opening of the housing 1. The internal spline is provided at the rear end inside the handle 2, providing an extended engagement length between the handle 2 and the housing 1. The handle 2 may be also operatively coupled to the threaded rod 31 through alternative drive connection mechanisms known in the art, configured to transmit rotational motion from the handle 2 to the threaded rod 31.

As shown in FIG. 7, in one embodiment, the rear end of the handle 2 is provided with a fixation element 22. The fixation element 22 is coupled to the rear end of the threaded rod 31 to ensure a reliable connection between the handle 2 and the threaded rod 31. The fixation element 22 may be a bolt. A plate is detachably coupled to the rear end of the handle 2 to conceal the fixation element 22, thereby enhancing the aesthetic appearance.

The handle 2 may be provided with a non-slip texture on its surface to enhance grip and facilitate rotational force application by a user.

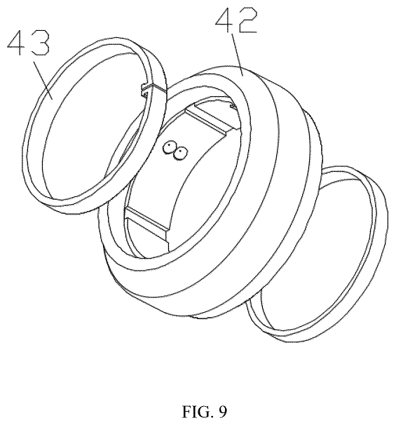

As shown in FIG. 1 and FIG. 8, in one embodiment, the container opener further includes a locking assembly 4. The locking assembly 4 is slidably mounted on the housing 1 and is configured to engage the handle 2. The locking assembly 4 is operable between a locked position engaging the handle 2 to prevent the handle 2 rotation thereof, and an unlocked position disengaged from the handle 2 to permit the handle 2 rotation thereof. After the length of the strip 33 is adjusted into position, the locking assembly 4 locks the relative position of the handle 2 and the housing 1, so that prevents the threaded rod 31 from rotating, thereby ensuring that the length of the strip 33 extending outside of the housing 1 remains fixed. Additionally, this engagement prevents the container opener from becoming loosely connected to the cap.

The locking assembly 4 includes an outer gear ring 41. The outer gear ring 41 is slidably mounted on the first section 11 along the longitudinal axis, and the front end of the handle 2 is provided with inner gear teeth 21 configured to engage with the outer gear ring 41. In the engaged state, the outer gear ring 41 and the inner gear teeth 21 cooperate to lock rotational motion of the handle 2 without restricting axial movement. To release the locking assembly 4, the outer gear ring 41 is slidably movable relative to the inner gear teeth 21 to achieve smooth disengagement.

The outer gear ring 41 includes an outer wall with a plurality of first gear teeth circumferentially spaced apart. Every first tooth extend along the axial direction of the housing 1. The inner gear teeth 21 are disposed on the inner wall of the handle 2. The distribution of the first gear teeth and the inner gear teeth is such that at least one of them is arranged over a full 360 degrees circumference. For example, the first gear teeth are arranged in a continuous 360 degrees circumferential array, and the inner gear teeth 21 are arranged in a segmented arcuate configuration spanning between 30 degrees to 360 degrees of the inner wall. The first gear teeth and the inner gear teeth 21 are configured for selective meshing engagement through axial displacement of the locking assembly.

An outer ring 42 is disposed on the outer gear ring 41 and is configured to enable a user to move the outer gear ring 41 by manipulating the outer ring 42. The outer ring 42 is sleeved over the outer gear ring 41 and coupled to an end of the outer gear ring 41 away from the handle 2, such that axial movement of the outer ring 42 adjusts the position of the outer gear ring 41. A gap is defined between the inner wall of the outer ring 42 and the outer gear ring 41, and the thickness of the gap is not less than that of the wall of the handle 2, thereby not interfering with the outer gear ring 41 into the handle 2.

The outer ring 42 may be connected to the distal end of the outer gear ring 41 via a rod or a plate.

When adjustment of the exposed length of the strip 31 outside the housing 1 is required, the outer ring 42 is slid to disengage the outer gear ring 41 from the inner gear teeth 21, thereby allowing free rotation of the handle 2 to drive the threaded rod 31 for length adjustment. Upon reaching the desired length of the strip 33, sliding the outer ring 42 causes the outer gear ring 41 to align with and mesh into the inner gear teeth 21, thereby locking both the handle 2 and the threaded rod 31 in position to prevent unintended rotation. The locking assembly 4 provides multiple contact points that engage with the handle 2, thereby ensuring a secure locking effect.

In one embodiment, the inner wall of the outer gear ring 41 defines a sliding groove extending along the longitudinal axis, the outer wall of the first section 11 is correspondingly provided with a ridge slidably coupled to the sliding groove as illustrated in FIG. 3. The ridge and the sliding groove provide guided linear motion for the movable outer gear ring 41. The one or more ridges may be circumferentially spaced along the first section 11, with one or more sliding grooves correspondingly arranged to align with the ridges.

The sliding range of the outer gear ring 41 allows both full disengagement and full engagement between the inner gear teeth 21 and the outer gear ring 41. Sliding the outer ring 42 to a maximum rearward position fully engages the outer gear ring 41 with the inner gear teeth 21, establishing a locked state. Sliding the outer ring 42 to a maximum forward position completely disengages the outer gear ring 41 from the inner gear teeth 21, establishing an unlocked state.

In one embodiment, the sliding range of the locking assembly 4 is defined by the rear edge of the second section 12 and the front edge of the handle 2. Since the cross-sectional dimension of the first section 11 is smaller than that of the rear end of the second section 12, when the outer gear ring 41 slides forward to its maximum extent, it contacts the rear edge of the second portion 12, thereby preventing the outer gear ring 41 from moving further forward. When the outer gear ring 41 slides backward to its maximum extent, the connection position between the outer gear ring 41 and the outer ring 42 contacts the front edge of the handle 2, thereby preventing the outer gear ring 41 from moving further backward.

In one embodiment, the housing 1 is provided with directional indicators on its outer surface as illustrated in FIG. 1 to denote rotating directions for locking or unlocking.

As shown in FIG. 5 and FIG. 9, in one embodiment, the locking assembly 4 also includes a washer 43 mounted on the first section 11. The washer 43 is interposed between the outer gear ring 41 and first section 11, and includes an outer wall in sliding contact with the inner wall of the outer gear ring 41.

Two washers 43 may be mounted over the first section 11 and are positioned at the front and rear ends of the ridge. The outer surfaces of the washers 43 are flush with the bottom surface of the ridge. This configuration ensures alignment between the washers 43 and the ridge, and allows the outer gear ring 41 to move smoothly.

The container opener provides a versatile and user-friendly solution for opening containers of different sizes. Its adjustment mechanism, locking assembly, and ergonomic design make it a significant improvement over traditional container opener.

A method of operating the container opener includes:
(a) sliding the locking assembly 4 to disengage the outer gear ring 41 from the inner gear teeth 21;
(b) rotating the handle 2 to drive rotation of the threaded rod 31, moving block 32 moving along the extension direction of the threaded rod 31, thereby adjusting the extended length of the strip 33 external to the housing 1, so that to adjust receiving space;
(c) inserting the cap into the receiving space composed of the extended part of the strip 33 and the arcuate surface, or moving the container opener and make the cap pass through the receiving space;
(d) rotating the handle 2 to establish tight contact between the strip 33, the friction portion 14, and the cap;
(e) sliding the locking assembly 4 to engage the outer gear ring 41 with the inner gear teeth 21, thereby locking the handle 2 in position and maintaining positional stability of the strip 33;
(f) rotating the entire container opener to cause the container opener carries the cap turn relative to the container; or rotating the entire container opener and container in opposite directions at the same time, thereby opening the cap.

In some application scenarios, the container opener may also be used as a tool to close the cap to the container. The container opener utilizes the lever principle to transfer the force applied to the cap to the container opener. The contact point between the cap and the container opening serves as a fulcrum of the lever, while the handle 2 acts as the other end of the lever. When force is applied to the handle 2 at a point away from the fulcrum, the cap can be opened or closed with less effort.

Finally, it should be noted that the foregoing descriptions are merely some embodiments of this application, and are not intended to limit this application, although this application is described in detail with reference to the foregoing embodiments, those skilled in the art may still modify the technical solutions described in the foregoing embodiments, or perform equivalent replacement on some technical features, and any modification, equivalent replacement, improvement, and the like made within the spirit and principle of this application shall be included in the protection scope of this application.

What is claimed is:

1. A container opener, comprising:
a housing, defining a cavity extending along a longitudinal axis from a front end adapted for engaging a container cap to a rear end opposite the front end;
an adjustment mechanism, disposed within the cavity, the adjustment mechanism comprising:
a guide member, disposed within the cavity and extending along the longitudinal axis;
a moving block, coupled to the guide member, and configured to move relative to the housing; and
a strip, partially positioned outside a front end of the housing, with two ends extending into the cavity and coupled to the moving block; and
a handle, operatively coupled to the adjustment mechanism to drive movement of the moving block.

2. The container opener according to claim 1, wherein:
(a) the guide member comprises:
(i) a threaded rod, rotatably coupled to the housing and extending along the longitudinal axis;
(ii) a rail, disposed within the cavity and parallel to the threaded rod;
(b) the moving block:
(i) defines a threaded bore engaged with the threaded rod;
(ii) includes a sliding interface mating with the rail for relative movement; and
(c) the handle is operatively coupled to the threaded rod to drive rotation thereof.

3. The container opener according to claim 1, wherein:
the front end of the housing defines two through-holes; and
the two ends of the strip extend into the cavity through the two through-holes and are respectively coupled to opposite sides of the moving block.

4. The container opener according to claim 3, wherein:
the housing comprises an arcuate surface positioned between the two through-holes;
the arcuate surface cooperates with a portion of the strip positioned outside the housing to define a receiving space; and
the receiving space is configured to receive the container cap.

5. The container opener according to claim 4, wherein:
at least one of the arcuate surface and the portion of the strip positioned outside the housing comprises a friction portion disposed on a side facing the receiving space.

6. The container opener according to claim 5, wherein the friction portion is elastic;
and/or, the friction portion comprises a plurality of protrusions.

7. The container opener of claim 2, wherein the handle is sleeved over a portion of the housing and rotatably coupled to the housing.

8. The container opener of claim 7, wherein:
the handle comprises a tubular structure, the tubular structure including an inner wall with an annular protrusion; and
the housing has an outer wall defining a corresponding annular groove, the annular groove is configured to slidably engage with the annular protrusion.

9. The container opener according to claim 2, wherein:
the threaded rod includes an external spline at a rear end thereof; and
the handle includes an internal spline cooperatively engaged with the external spline.

10. The container opener of claim 9, wherein the internal spline is disposed at a rear end of the handle.

11. The container opener according to claim 2, wherein the handle includes a fixation element coupled to the rear end of the threaded rod.

12. The container opener according to claim 2, wherein the housing sequentially comprises:
(a) a first section, including:
a rear end defining an opening corresponding to the rear end of the threaded rod; and;
the handle rotatably mounted on the first section and drivingly coupled to the threaded rod via the opening;
(b) a second section extending from a front end of the first section, and including:
a rear end with a cross-sectional dimension larger than a cross-sectional dimension of the first section; and
a front end defining two through-holes for the strip.

13. The container opener according to claim 12, wherein:
a front end of the threaded rod is rotatably coupled to the front end of the second section; and
a rear end of the threaded rod is rotatably coupled to the rear end of the first section.

14. The container opener according to claim 12, wherein the first section tapers in cross-sectional dimension from the front end to rear end.

15. The container opener according to claim 2, further comprising:
a locking assembly slidably mounted on the housing and operable between:
a locked position engaging the handle to prevent rotation thereof; and
an unlocked position disengaged from the handle to permit rotation thereof.

16. The container opener according to claim 15, wherein the locking assembly comprises:
an outer gear ring slidably mounted on the housing along the longitudinal axis; the handle having an inner wall with inner gear teeth; the inner gear teeth configured to engage the outer gear ring; and
an outer ring surrounding the outer gear ring and coupled to an end of the outer gear ring distal from the handle, wherein a gap between an inner wall of the outer ring and an outer wall of the outer gear ring has a thickness not less than a wall thickness of the handle.

17. The container opener according to claim 16, wherein:
the outer gear ring defines a sliding groove extending along the longitudinal axis on an inner wall thereof; and
the housing includes a ridge protruding from an outer wall thereof and slidably coupled to the sliding groove.

18. The container opener according to claim 16, wherein the outer gear ring comprises: first teeth circumferentially spaced along the outer wall thereof; and at least one of the first gear teeth or the inner gear teeth are distributed over an entirety of a 360 degrees circumference.

19. The container opener according to claim 16, wherein the locking assembly further comprises:
a washer mounted on the housing and interposed between the outer gear ring and housing, the washer having an outer wall in sliding contact with the inner wall of the outer gear ring.

20. A container opener comprising:
a housing, defining a cavity extending along a longitudinal axis from a front end adapted for engaging a container cap to a rear end opposite the front end;
an adjustment mechanism, disposed within the cavity, the adjustment mechanism comprising:
a guide member, disposed within the cavity and extending along the longitudinal axis;
a moving block, coupled to the guide member, and configured to move relative to the housing; and
a strip, partially positioned outside a front end of the housing, with two ends extending into the cavity and coupled to the moving block;
a handle, operatively coupled to the adjustment mechanism to drive movement of the moving block; and
a locking assembly, slidably mounted on the housing and operable between:
a locked position engaging the handle to prevent movement thereof; and
an unlocked position disengaged from the handle to permit movement thereof.
